(19) United States
(12) Patent Application Publication
(10) Pub. No.: US 2026/0046301 A1
(43) Pub. Date: Feb. 12, 2026

(54) PROVABLE REMOTE ATTESTATION OF COMPUTING ASSETS USING SBOMS

(71) Applicant: Cisco Technology, Inc., San Jose, CA (US)

(72) Inventors: Thomas Szigeti, Vancouver (CA); Vincent E. Parla, North Hampton, NH (US)

(21) Appl. No.: 18/799,187

(22) Filed: Aug. 9, 2024

(51) Int. Cl. H04L 9/40

(52) U.S. Cl. CPC H04L 63/1433

(57) ABSTRACT

A method, computer system, and computer program product are provided for generating and analyzing remotely attested SBOMs. Instructions are provided to cause a plurality of network devices in a network to each generate a software bill of materials (SBOM), wherein each network device self-attests the SBOM that describes that network device. The SBOM is obtained from each of the plurality of network devices. Each SBOM is analyzed to identify a particular software configuration in the network. A vulnerability is identified in the network based on the particular software configuration.

### TECHNICAL FIELD

The present disclosure relates generally to cybersecurity and provable remote attestation.

### BACKGROUND

A Software Bill of Materials (SBOM) is a detailed listing of software components within an application, microservice, network device, or endpoint device. An SBOM can describe the underlying software components of an application, including any libraries, dependencies, repositories, and/or open-source code that are in use. Using SBOMs, an enterprise can determine if any of the underlying software components pose a risk to an application or to users.

However, producers of SBOMs are generally limited in scope to a specific layer (or a few select layers) of a technology stack. For example, producers of SBOMs for containerized microservices have no awareness of SBOMs for the pipeline, the network, or the client endpoints, and vice versa.

### BRIEF DESCRIPTION OF THE DRAWINGS

FIG. 1 is a block diagram depicting a network environment for an enterprise campus, data center, and cloud providers, in which the techniques presented herein may be employed, according to an example embodiment.

FIG. 2 is a block diagram depicting a network environment for generating and analyzing remotely attested SBOMs, according to an example embodiment.

FIG. 3 is a block diagram depicting a network environment for generating and analyzing remotely attested SBOMs, according to an example embodiment.

FIG. 4 is a block diagram depicting a network environment in which remotely attested SBOMs are analyzed, according to an example embodiment.

FIG. 5 is a block diagram depicting a network path trace, according to an example embodiment.

FIG. 6 is a flow chart depicting a method for generating and analyzing remotely attested SBOMs, according to an example embodiment.

FIG. 7 is a block diagram of a device that may be configured to perform operations relating to remote generation and attestation of SBOMs, as presented herein.

### DETAILED DESCRIPTION

### Overview

According to one embodiment, techniques are provided for generating and analyzing remotely attested SBOMs. Instructions are provided to cause a plurality of network devices in a network to each generate a software bill of materials (SBOM), wherein each network device self-attests the SBOM that describes that network device. The SBOM is obtained from each of the plurality of network devices. Each SBOM is analyzed to identify a particular software configuration in the network. A vulnerability is identified in the network based on the particular software configuration.

### Example Embodiments

Present embodiments relate to cybersecurity, and more specifically, to using SBOMs that are remotely self-attested by devices to identify and remediate software vulnerabilities. Conventional approaches to using SBOMs involve analyzing a computing device’s SBOM to identify any known vulnerabilities present in the device. However, some exploits target vulnerabilities that exist across layers of a technology stack (which may span multiple devices). These vulnerabilities may not be present in any one particular device, but instead exist by way of a specific combination of multiple devices that are in communication with each other. For example, a vulnerability may be exploitable only when a server is running a specific version of host software and an endpoint device is also running a specific version of client software.

To protect against such exploits, security tools would benefit from an end-to-end awareness of the SBOMs in use across a technology stack. The embodiments presented herein solve this problem by securely compiling (with provable remote attestation) SBOMs and correlating the SBOMs across layers of a full technology stack to provide comprehensive observability into software vulnerabilities. Since the SBOMs are compiled using provable remote attestation, the SBOMs can be trusted when analyzed in accordance with the techniques presented herein. By obtaining SBOMs for multiple devices across a technology stack, vulnerabilities that would otherwise been undetectable can be identified and remediated. Thus, the embodiments presented herein improve the technical field of cybersecurity by automatically identifying vulnerabilities that are present in combinations of software configurations of devices. By obtaining and analyzing remotely-attested SBOMs, the embodiments presented herein provide several practical applications, including identifying vulnerabilities more quickly by focusing analysis on devices that have recently been upgraded, enabling vulnerabilities to be identified in specific network paths, enabling vulnerabilities to be identified that are present in different layers of a stack, and the like.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

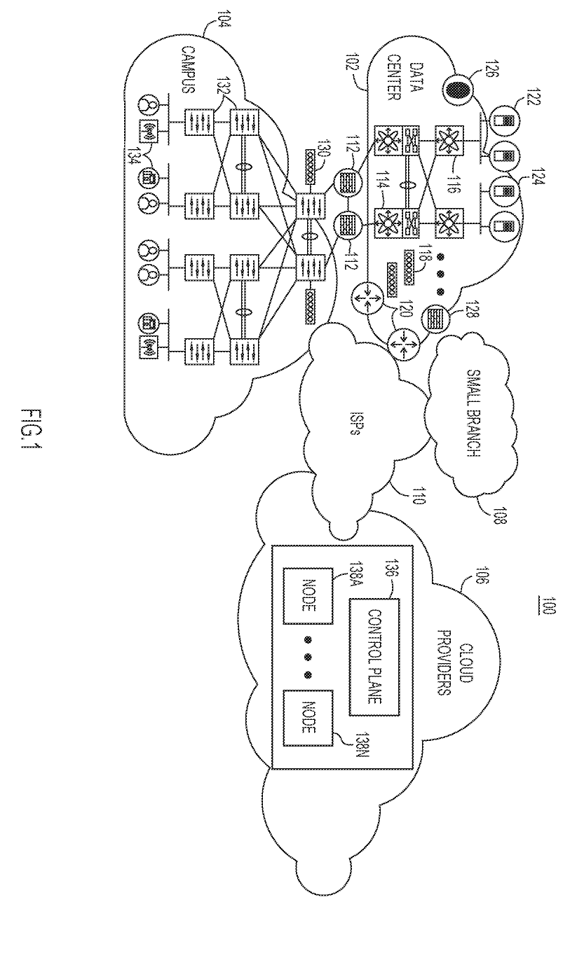

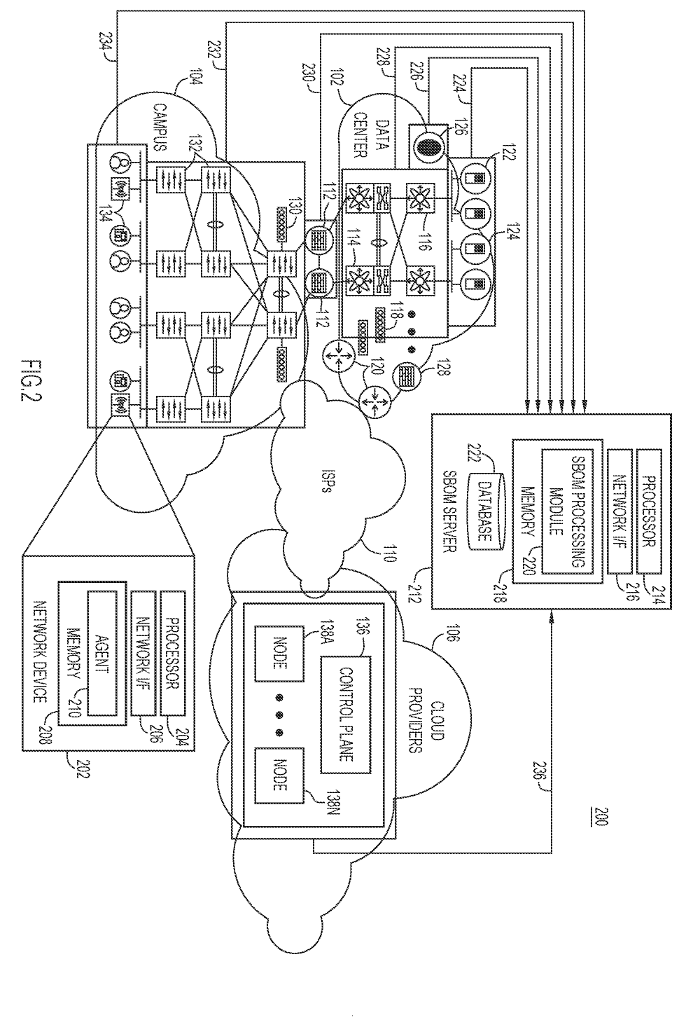

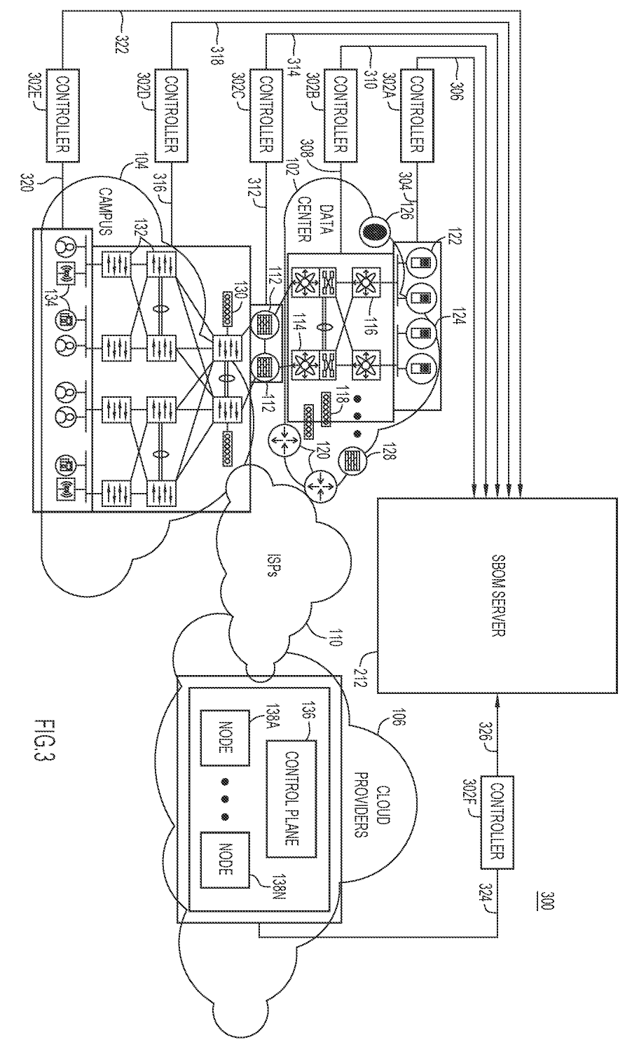

With reference now to FIG. 1, a block diagram is presented depicting a network environment 100 for a network environment for an enterprise campus, data center, and cloud providers, in which the techniques presented herein may be employed according to an example embodiment. As depicted, network environment 100 includes a data center 102, an enterprise campus 104, cloud providers 106, and a small branch 108 that are in communication with each other via one or more networks (Internet Service Providers (ISPs) 110). Each computing and/or networking device in network environment 100 may include a network interface (I/F) and at least one processor (computer processor), memory, storage, and/or other computing and/or networking components (e.g., graphics cards, displays, input/output devices, etc.). It is to be understood that the functional division among components have been chosen for purposes of explaining various embodiments and is not to be construed as a limiting example. As an example of a conventional network environment, network environment 100 is depicted and described for the purpose of facilitating understanding of the example embodiments presented herein (e.g., the embodiments that are depicted and described with reference to FIGS. 2 and 3).

Data center 102 may include a plurality of computing and/or networking devices that are configured to store data and/or enable the data to be accessed. Firewalls 112 can be provided that apply policies to traffic between data center 102 and campus 104. As depicted, data center 102 includes edge switches 114, switches 116, wireless local area network (WLAN) controllers (WLCs) 118, routers 120, shared services 122, application servers 124, and identity services 126. Edge switches 114, switches 116, WLCs 118, and routers 120 collectively enable the exchange of data through the network of data center 102. Shared services 122 and/or application servers 124 can host various services or applications, performing processing operations such as code execution, acting as databases, executing database queries, and the like. Identity services 126 can authenticate client devices to ensure that only authorized users can access the network and resources of data center 102. Data center 102 may include a wireless controller 128 that can tunnel client data, switch data locally, perform client authentication, and the like.

Campus 104 may be a network at a particular site, such as an enterprise or school, that includes end users of services provided by data center 102 and/or cloud providers 106. Campus 104 may include one or more WLCs 130 that service as wireless access points, a plurality of switches 132, and endpoint devices 134, which can include laptops, desktops, smartphones, tablets, and the like. Small branch 108 may include a network that is configured similarly to campus 104, with endpoint devices, wireless access points, and the like.

Cloud providers 106 can include one or more cloud platforms that can provide various cloud services. Cloud providers 106 may include hardware and/or software components in order to host containerized applications, virtual machines, and the like. Control plane 136 can manage the state of a cluster of nodes 138A – 138N, each of which implementing one or more containerized applications and/or virtual machines.

ISPs 110 can include one or more ISPs that provide internet connectivity to facilitate the exchange of data between any internet-accessible assets, including data center 102, campus 104, cloud providers 106, and/or small branch 108. ISPs 110 can provide a variety of functions, including data routing and traffic management, redundancy, quality of service policies, and the like.

With reference now to FIG. 2, a block diagram is provided depicting a network environment 200 for generating and analyzing remotely attested SBOMs, according to an example embodiment. As depicted, network environment 200 includes elements that are depicted and described with reference to FIG. 1, including data center 102, campus 104, cloud providers 106, and ISPs 110. Network environment 200 also includes an example of a network device 202 that includes an agent 210 for generating self-attested SBOMs, and an SBOM server 212 that serves as a centralized SBOM storage and analysis platform.

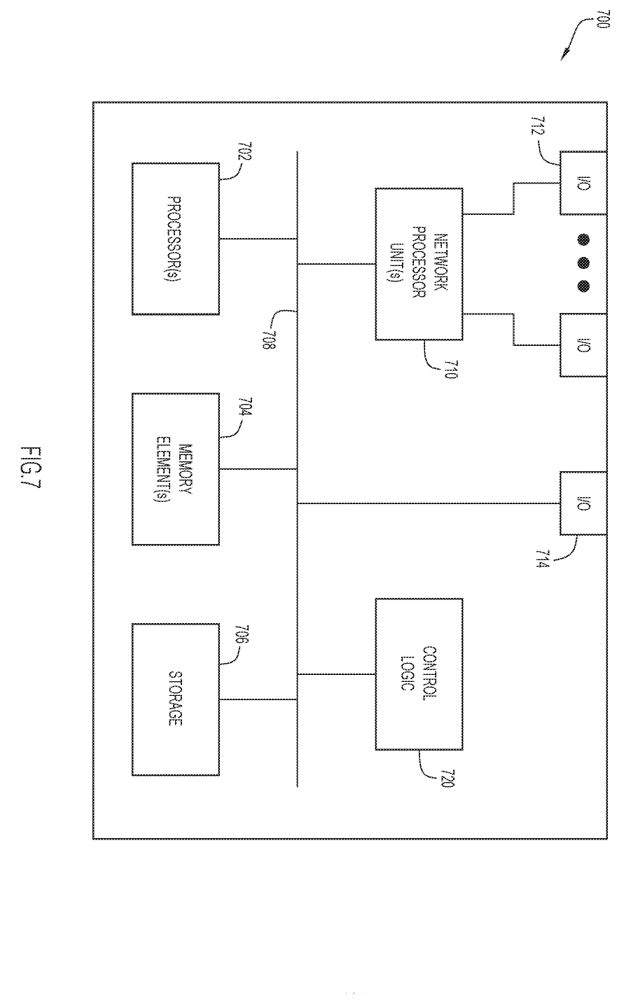

Network device 202 may represent any computing or networking device in network environment 200 that is configured in accordance with the embodiments presented herein. Network device 202 includes at least one processor 204, a network interface (I/F) 206, and memory 208, which stores software instructions for agent 210. Network device 202 may include an endpoint device (e.g., a desktop computer, a laptop computer, a thin client, a smartphone, a tablet), a server, a router, a switch, a firewall, or any other programmable electronic device or virtual computing device capable of executing computer readable program instructions. Network interface 206 enables components of network device 202 to send and receive data over a network. Network device 202 may include internal and external hardware components, as depicted and described in further detail with respect to FIG. 7.

Agent 210 is a software module that can be installed on any networking device in network environment 200. Agent 210 may be configured to obtain information about any software that is installed on the networking device on which agent 210 is also installed. In the example embodiment of network environment 200, a software agent may be installed on one or more networking devices (e.g., any devices of data center 102, campus 104, cloud providers 106, and/or ISPs 110), thus enabling the networking devices to generate self-attested SBOMs.

Agent 210 may query the network device 202 upon which agent 210 is installed in order to determine a version of one or more software applications installed on the network device 202. Agent 210 can execute a “show version” command that returns the software version information for any software applications installed on the network device 202. In some embodiments, the show version command is a function that is native to the operating system of network device 202. In some embodiments, agent 210 may identify any executable applications installed on network device 202 and execute a command to return the version of the software. Thus, agent 210 can determine the version information for all software applications on network device 202.

Agent 210 may use the software version information to generate an SBOM, which can be a listing of the software versions of each application installed on network device 202. The SBOM can correspond to a particular format, such as an extensible markup language (XML) document, a JavaScript® Object Notation (JSON) document, a CycloneDX document, and the like. In some embodiments, the SBOM is formatted in a hierarchical manner in which any application or library dependencies are indicated.

Agent 210 can then self-attest the SBOM. In some embodiments, the SBOM is self-attested by signing the SBOM with a manufacturer’s certificate (i.e., the certificate provided by a manufacturer of network device 202). The manufacturer may provide each device with a unique certificate that is signed with a private key and contains the device's public key (and optionally, other identifying information such as a universally unique identifier (UUID) or other identifier for each device). In some embodiments, a nonce is included with the SBOM. The nonce may be a random number used only once in order to ensure that old communications cannot be reused in replay attacks. Network device 202 may receive the nonce from SBOM server 212 and can combine the nonce with the SBOM to be attested. Agent 210 can generate a hash of the combined nonce and SBOM, and using a private key of network device 202 (which corresponds to the public key in the manufacturer's certificate), agent 210 signs this hash, which serves as the attestation. Thus, the agent 210 can provide the self-attested SBOM to SBOM server 212 for analysis in accordance with the embodiments presented herein. The SBOMs can be generated according to a predetermined schedule (e.g., once every twenty-four hours) or on an ad hoc basis (e.g., when a new software installation or update is detected). In various embodiments, the agent 210 can provide the SBOMs as a response to a pull request (e.g., a request from SBOM server 212) and/or the agent 210 can pushed to the SBOM to the SBOM server 212.

SBOM server 212 includes at least one processor 214, a network interface (I/F) 216, memory 218 (which stores software instructions for an SBOM processing module 220), and database 222. SBOM server 212 may include any programmable electronic device or virtual computing device capable of executing computer readable program instructions. Network interface 216 enables components of SBOM server 212 to send and receive data over a network. In some embodiments, SBOM server 212 may be a full-stack observability or universal data plane (FSO/UDP) platform that ingests metrics, events, logs, and traces, and/or other telemetry data. SBOM server 212 may include internal and external hardware components, as depicted and described in further detail with respect to FIG. 7.

SBOM processing module 220 may perform various operations relating to the generation, collection, and/or analysis of SBOMs. In some embodiments, SBOM processing module 220 requests SBOMs from network devices; the network devices may each provide a most recently generated and attested SBOM or may generate and self-attest an SBOM in response to receiving a request. In other embodiments, SBOM processing module 220 may receive SBOMs from network devices based on a push model. SBOM processing module 220 may organize and store SBOMs in a database (e.g., database 222) for further analysis. The SBOM processing module 220 may correlate each SBOM with an identity of the network device to which each SBOM describes.

In some embodiments, SBOM processing module 220 may analyze SBOMs to identify vulnerabilities present in one or more network devices. In some embodiments, a listing of software components that are known to have vulnerabilities may be analyzed in combination with the SBOMs to determine whether an enterprise has any vulnerable network devices. In some embodiments, SBOM processing module 220 may compare SBOMs of different network devices (or combinations of network devices) to identify vulnerabilities in a network. When different network devices experience common errors, common security events, or other common events, SBOM processing module 220 can compare the SBOMs to identify any common software components, which may be determined to be responsible for the error, security event, or other event. SBOM processing module 220 can likewise compare multiple SBOMS of combinations of network devices, such as network devices that are members of a particular network path, to SBOMS of other combinations of network devices (e.g., devices belonging to a different network path) in order to identify vulnerabilities based on any common software configurations at the network path level (e.g., common software configuration elements that involve two or more software applications installed on two or more different network devices in a same network path).

In some embodiments, SBOM processing module 220 may employ a machine learning model to identify vulnerabilities using SBOMs. A machine learning model can be trained using examples of combinations of SBOMs from different network devices that are labeled with respect to the presence or absence of a vulnerability. The machine learning model can be trained until a desired level of accuracy is achieved (e.g., using a reserved portion of the training data as testing data), and then applied to analyze the SBOMs obtained by SBOM server 212. The machine learning model can be retrained as new SBOM data becomes available in order to increase the accuracy of the machine learning model and/or to adjust the model to detect new vulnerabilities (e.g., as zero-day exploits become known). Additionally or alternatively, training data can include behavioral graphs of previously-observed network behavior. Each behavioral graph may include control flow sequences that indicate the execution of low-level processor instructions, higher level functional call sequences with call parameters being passed to the functions, and the like. The behavioral graphs can be labeled with details from SBOMs indicating the software components associated with each control flow sequence. Using behavioral graphs, a machine learning model can be trained to identify unknown vulnerabilities in new behavioral graph data by identifying deviations in execution in the new behavioral graph data as compared to the previously-observed network behavior represented in the training behavioral graph data. Thus, a machine learning model can be trained to identify vulnerabilities present in combinations of software elements that are installed on different network devices.

In some embodiments, SBOM server 212 analyzes the SBOMs to determine a trust score for a network. Based on a number of vulnerabilities, the trust score can be computed by assigning a numerical value to each vulnerability. Different types of vulnerabilities can be assigned different weights or otherwise scored differently, enabling some vulnerabilities to have a greater influence over the trust score as compared to other vulnerabilities. In some embodiments, the types of vulnerabilities are determined according to which type/role of device the vulnerability affects, such as an endpoint device, router, firewall, switch, server, and the like.

Database 222 may include any non-volatile storage media known in the art. For example, database 222 can be implemented with a tape library, optical library, one or more independent hard disk drives, multiple hard disk drives in a redundant array of independent disks (RAID), solid state storage media, and the like. Similarly, data stored in database 222 may conform to any suitable storage architecture known in the art, such as a file, a relational database, an object-oriented database, and/or one or more tables. Database 222 may store SBOMs that are obtained or received from any network devices in network environment 200. Each SBOM may be correlated with the particular network device that is described by the SBOM, and multiple SBOMs can be associated with a single network device (e.g., different SBOMs for different possible configurations and/or time-series SBOM data corresponding to SBOMs generated at particular times).

With reference still to FIG. 2, operations 224, 226, 228, 230, 232, and 234 are depicted as example SBOM obtaining/requesting operations between various network devices and SBOM server 212. At each operation depicted, agents (such as agent 210) are installed at the respective network devices and are configured to generate and attest SBOMs that are then obtained by, or provided to, SBOM server 212. At operation 224, application runtime agents may generate signed SBOM information describing applications running on application servers 124. At operation 226, signed SBOM information can likewise be generated by agents running on identity services 126. At operation 228, agents running on network devices (e.g., switches 116 and/or WLCs 118) generate signed SBOM information for the respective network devices. At operation 230, security agents installed on firewalls 112 generate signed SBOM information for firewalls 112. At operation 232, network agents installed on network devices generate signed SBOM information for those devices (e.g., switches 132). At operation 234, endpoint device agents installed on endpoint devices 134 generate signed SBOM information for the endpoint devices 134. At operation 236, cloud infrastructure agents generate signed SBOM information describing cloud assets (e.g., nodes 138A – 138N). Each agent can transmit the signed SBOM information to SBOM server via pull or push operations, and the generation and signing of SBOMs can be performed independently from, or in response to, a request for SBOM information.

With reference now to FIG. 3. a block diagram is provided depicting a network environment 300 for generating and analyzing remotely attested SBOMs, according to an example embodiment. As depicted, network environment 300 includes elements that are depicted and described with reference to FIG. 1, including data center 102, campus 104, cloud providers 106, and ISPs 110. Network environment 300 also includes an example of an SBOM server 212 and a plurality of network controllers (e.g., controllers 302A, 302B, 302C, 302D, 302E and 302F).

In the example embodiment of FIG. 3, network environment 300 may generate and attest SBOMs using network controllers rather than agents that are installed on each network device. Each controller 302A – 302F may be configured to manage, configure, monitor, and/or troubleshoot other physical and/or virtual network devices. As such, each controller 302A – 302F can have knowledge of the software elements that are installed on the devices controlled by each respective controller 302A – 302F. Each controller 302A – 302F may be configured to generate and self-attest SBOMs for any devices that it manages, as well as SBOMs describing each respective controller 302A – 302F.

In the example embodiment of network environment 300, each controller 302A – 302F is responsible for one or more network devices. In some embodiments, any of controllers 302A – 302F can include a vulnerability manager that gathers and exports digitally-signed SBOM information for client endpoints, including firmware versions. In some embodiments, any of controllers 302A – 302F can include a network dashboard that gathers and exports digitally-signed SBOM information for wired and/or wireless devices (e.g., switches, routers, wireless access points, wireless controllers, etc.). In some embodiments, any of controllers 302A – 302F can include a security server that gathers and exports digitally-signed SBOM information for security elements, such as firewalls, intrusion detection systems (IDSes), intrusion prevention systems (IPSes), web application firewalls (WAFs), and the like. In some embodiments, any of controllers 302A – 302F can include a policy infrastructure controller that gathers and exports digitally-signed SBOM information for data center switches and fabrics. In some embodiments, any of controllers 302A – 302F can include a software-as-a-service (SaaS) management platform that gathers and exports digitally-signed SBOM information for physical and/or virtual machines. In some embodiments, any of controllers 302A – 302F can include a runtime security platform that gathers and exports digitally-signed SBOM information for applications. In some embodiments, any of controllers 302A – 302F can include a real-time attack detection platform that gathers and exports digitally-signed SBOM information for cloud native applications and infrastructure (e.g., containerized application platforms, service meshes, continuous integration and continuous delivery (CI/CD) platforms, etc.).

Accordingly, each controller 302A – 302F obtains or receives data indicating the software configuration of devices that the controller manages. At operation 304, controller 302A obtains or receives data from shared services 122 and/or application servers 124. Controller 302A may then generate and self-attest an SBOM for each shared service 122 and/or application server 124, and provide the attested SBOMs to SBOM server 212 at operation 306. Controller 302B obtains or receives data from switches 116 and/or WLCs 118 at operation, 308 and likewise generates and self-attests SBOMs and provides them to SBOM server 212 at operation 310. Controller 302C obtains or receives data from firewalls 112 at operation 312, and generates and self-attests SBOMs and provides them to SBOM server 212 at operation 314. Controller 302D obtains or receives data from switches 132 at operation 316, and generates and self-attests SBOMs and provides them to SBOM server 212 at operation 318. Controller 302E obtains or receives data from endpoint devices 134 at operation 320, and generates and self-attests SBOMs and provides them to SBOM server 212 at operation 322. Controller 302F obtains or receives data from cloud assets (e.g., nodes 138A – 138N) at operation 324, and generates and self-attests SBOMs and provides them SBOM server 212 at operation 326.

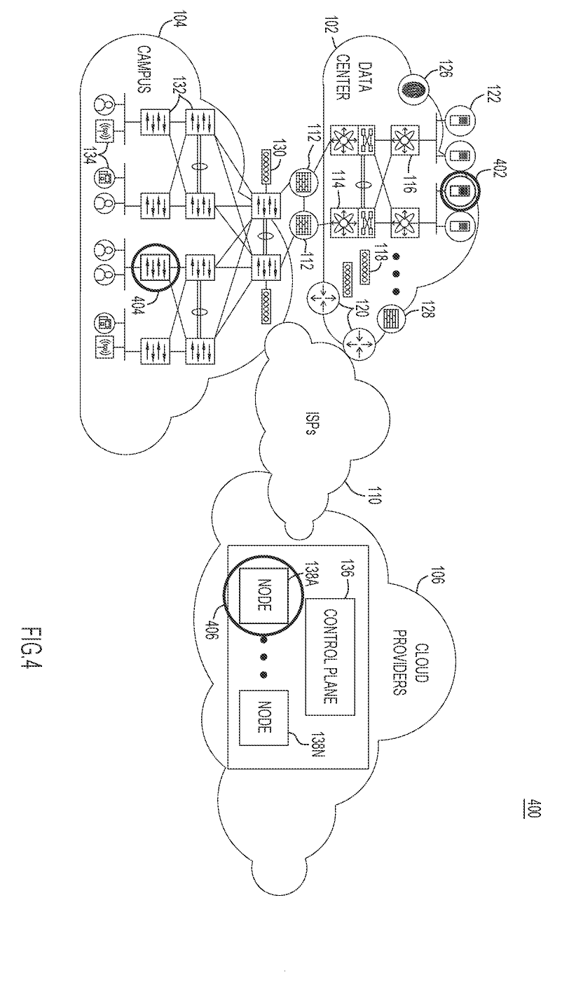

With reference now to FIG. 4, a block diagram is provided depicting a network environment 400 in which remotely attested SBOMs are analyzed, according to an example embodiment. SBOMs can be analyzed in order to identify particular physical and/or virtual computing assets that have recently received software upgrades or new installations of software applications. In the depicted example, the SBOMs for each device in network environment 400 can be analyzed to determine that application server 402, endpoint device 404, and cloud computing node 406 have recently received updates to their software configurations. In some embodiments, a visualization of network environment 400 is provided to a user interface so that recently-updated elements can be visually presented to a user.

In some embodiments, SBOMs are analyzed to identify updated devices in network environment 400 by comparing time-series SBOMs for each device to identify changes from one SBOM to another (e.g., a difference between two chronologically-sequential SBOMs). In some embodiments, when SBOMs are generated, an installation or update timestamp can be included with each software element described in the SBOMs. Thus, SBOMs can be searched based on a date or range of dates to identify updated software configurations for any desired time window. In some embodiments, when a software version is known to represent a new update, the SBOMs can be queried to identify any software configurations that include that software version. By identifying recently-upgraded computing assets, any errors or software vulnerabilities can be identified (e.g., by focusing analysis on those computing assets) in a faster manner in which fewer computing resources are consumed.

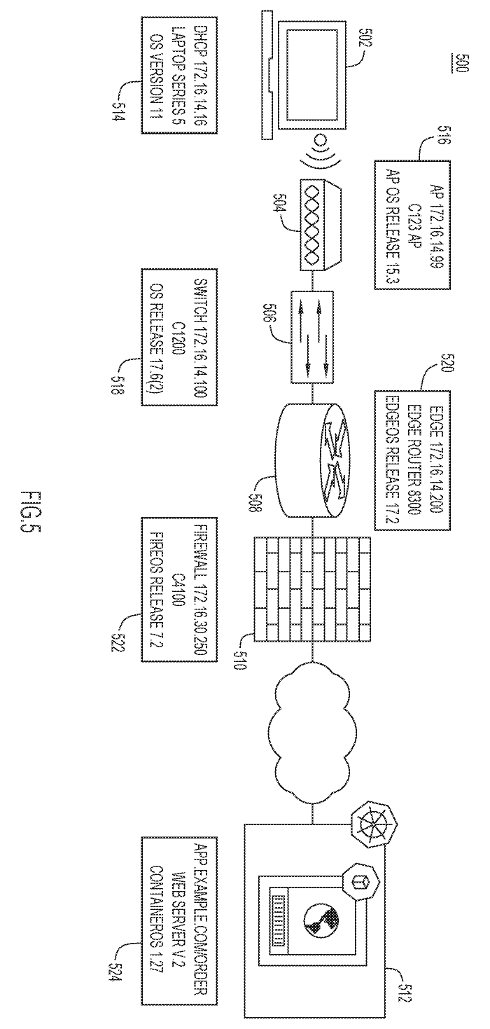

With reference now to FIG. 5, a block diagram is shown depicting a network path trace 500, according to an example embodiment. The network path trace 500 illustrates a path of devices that are traversed from a client to an application, and can be determined using a trace route command. As depicted, network path trace 500 includes a client device 502, a wireless access point 504, a switch 506, a router 508, a firewall 510, and a web application 512. Also depicted are examples of SBOMs for each computing entity (i.e., SBOM 514, SBOM 516, SBOM 518, SBOM 520, SBOM 522, and SBOM 524). Each SBOM can be generated and self-attested in accordance with the embodiments presented herein.

After obtaining network path trace 500, a server (e.g., SBOM server 212) can identify the SBOM for each computing entity either by network address or using another identifier. In the depicted example, the category of computing element, the computing hardware and/or the software are indicated by each SBOM. For example, SBOM 514 indicates that client device 502 is a “laptop series 5” running an “OS version 11”. Similarly, SBOM 516 indicates that wireless access point 504 is a “C123 AP” running “AP OS Release 15.3”, SBOM 518 indicates that switch 506 is a “C1200” switch running “OS release 17.6(2)”, SBOM 520 indicates that router 508 is an “Edge Router 8300” running “EdgeOS Release 17.2”, SBOM 522 indicates that firewall 510 is a “C4100” firewall running “FireOS Release 7.2), and SBOM 524 indicates that web application 512 is a “Web Server V.2” executing in a container running “ContainerOS 1.27”.

By generating path trace views that populate each device with a corresponding SBOM, a network path can be analyzed to identify any vulnerabilities, including vulnerabilities present in particular devices as well as vulnerabilities that are present by way of combinations of devices. For example, a vulnerability may be present in network path trace 500 due to client device 502 having a specific operating system (OS Version 11) in combination with switch 506 having a specific operating system (OS Release 17.6(2)). Thus, network traffic that travels this path may be exposed due to this vulnerability. In some embodiments, when a vulnerability is detected based on a combination of devices, a network path can be automatically rerouted to remediate the vulnerability. Thus, the traffic from client device 502 may be rerouted to a different switch having a different operating system so that the vulnerability is no longer present. Additionally, when a vulnerability is identified in a network path, other network paths that are similar to the vulnerable network path may be identified in order to assess those network paths for vulnerabilities as well. The similar network paths can be identified based on a presence of common network devices; for example, if another client device also uses the path shown in network path trace 500, then there may be a vulnerability with regard to that client device as well. Similar network paths may not necessarily include the same physical computing entities, however, as similar network paths can be identified in which a different network device or set of network devices share same software configurations as the vulnerable network path.

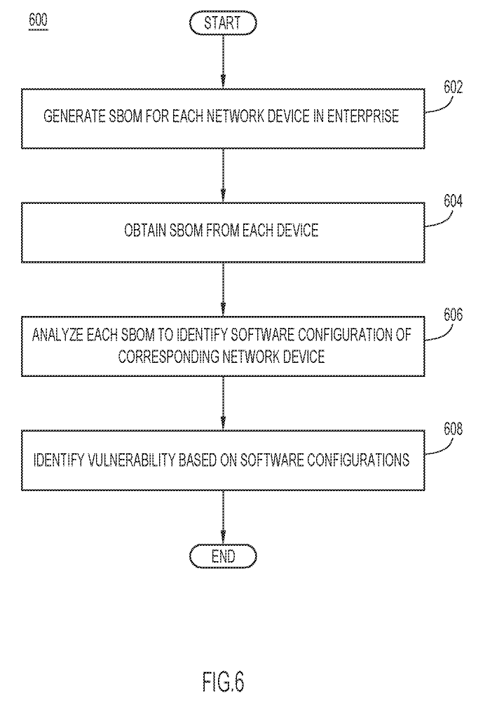

With reference to FIG. 6, a flow chart is provided depicting a method 600 for generating and analyzing remotely attested SBOMs, according to an example embodiment.

At operation 602, an SBOM is generated for each network device in a network. The network may be an enterprise network. Each SBOM can be generated either by a network device itself (e.g., via an agent that is installed on the device) or by a controller that manages the network device. Information that is used for generating an SBOM can be obtained by executing a command on each network device that returns a listing of installed software elements, versions of each software element, and optionally, other information such as a timestamp indicating when each software element was installed. When an SBOM is generated, the SBOM can be self-attested by the device generating the SBOM. In particular, each SBOM can be digitally signed with a certificate that ensures that the data in the SBOM is trustworthy.

The SBOMs can be obtained from each network device at operation 604. The SBOMs can be provided to, or obtained by, a server that manages SBOMs for a network (e.g., an enterprise network). The server may manage SBOMs in a database that associates each SBOM with an identity of the network device to which the SBOM corresponds. In some embodiments, multiple SBOMs may be correlated to a same network device, such as two or more different SBOMs that were generated at different points in time. Thus, a database of SBOMs can provide a historical as well as current view of the software configurations of each network device in the network.

At operation 606, each SBOM is analyzed to identify a software configuration of the corresponding network devices. In some embodiments, SBOMs are analyzed using a list of software elements that are known to have vulnerabilities. In other embodiments, vulnerabilities may be present by way of a combination of different software elements installed on two or more devices. These vulnerabilities can be identified by analyzing an SBOM in combination with one or more other SBOMs to identify if the vulnerability is present. When such a vulnerability is identified, the analysis may further include determining whether the corresponding network devices communicate with each other. For example, if the vulnerability is potentially present because of a first software element that is installed on a client device and a second software element that is installed on a router, then the vulnerability may not exist if the client device resides on a different campus than the router.

At operation 608, a vulnerability is identified based on the software configurations. Once a vulnerability is identified, the vulnerability may be automatically remediated by updating or rolling back a software update to a network device and/or by rerouting a network path to eliminate the vulnerability.

Referring now to FIG. 7, FIG. 7 illustrates a hardware block diagram of a computing device 700 that may perform functions associated with operations discussed herein in connection with the techniques depicted in FIGS. 1 – 6. In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O 714 allow for input and output of data and/or information with other entities that may be connected to computing device 700. For example, I/O 714 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

In some aspects, the techniques described herein relate to a computer-implemented method including: providing instructions to cause a plurality of network devices in a network to each generate a software bill of materials (SBOM), wherein each network device self-attests the SBOM that describes that network device; obtaining the SBOM from each of the plurality of network devices; analyzing each SBOM to identify a particular software configuration in the network; and identifying a vulnerability in the network based on the particular software configuration.

In some aspects, the techniques described herein relate to a computer-implemented method, wherein the instructions to cause each network device to generate an SBOM are provided to an agent that is installed on each network device, and wherein the agent generates and self-attests the SBOM.

In some aspects, the techniques described herein relate to a computer-implemented method, wherein the instructions to cause each network device to generate the SBOM are provided to a controller that manages one or more network devices of the plurality of network devices, and wherein the controller generates and self-attests the SBOM for each of the one or more network devices.

In some aspects, the techniques described herein relate to a computer-implemented method, further including: identifying a subset of network devices that correspond to a particular network path through the network; and analyzing the SBOM for each of the subset of network devices to identify a particular vulnerability that is present due to a combination of software installed on the subset of network devices.

In some aspects, the techniques described herein relate to a computer-implemented method, wherein the vulnerability is identified based on the particular software configuration using a machine learning model.

In some aspects, the techniques described herein relate to a computer-implemented method, further including: analyzing each SBOM to identify a subset of the plurality of network devices that have received a software upgrade within a predetermined duration of time.

In some aspects, the techniques described herein relate to a computer-implemented method, wherein the instructions to cause a plurality of network devices to each generate the SBOM are executed by each network device according to a predetermined schedule.

In some aspects, the techniques described herein relate to a computer-implemented method, further including: analyzing each SBOM to generate a trust score for the network.

In some aspects, the techniques described herein relate to a computer-implemented method, wherein the vulnerability is identified in multiple network devices or combinations of network devices by analyzing each SBOM to identify common software that is installed on the multiple network devices or the combinations of network devices.

In some aspects, the techniques described herein relate to a system including: one or more computer processors; one or more computer readable storage media; and program instructions stored on the one or more computer readable storage media for execution by at least one of the one or more computer processors, the program instructions including instructions to: provide instructions to cause a plurality of network devices in a network to each generate a software bill of materials (SBOM), wherein each network device self-attests the SBOM that describes that network device; obtain the SBOM from each of the plurality of network devices; analyze each SBOM to identify a particular software configuration in the network; and identify a vulnerability in the network based on the particular software configuration.

In some aspects, the techniques described herein relate to a system, wherein the instructions to cause each network device to generate an SBOM are provided to an agent that is installed on each network device, and wherein the agent generates and self-attests the SBOM.

In some aspects, the techniques described herein relate to a system, wherein the instructions to cause each network device to generate the SBOM are provided to a controller that manages one or more network devices of the plurality of network devices, and wherein the controller generates and self-attests the SBOM for each of the one or more network devices.

In some aspects, the techniques described herein relate to a system, wherein the program instructions further include instructions to: identify a subset of network devices that correspond to a particular network path through the network; and analyze the SBOM for each of the subset of network devices to identify a particular vulnerability that is present due to a combination of software installed on the subset of network devices.

In some aspects, the techniques described herein relate to a system, wherein the vulnerability is identified based on the particular software configuration using a machine learning model.

In some aspects, the techniques described herein relate to a system, further including instructions to: analyze each SBOM to identify a subset of the plurality of network devices that have received a software upgrade within a predetermined duration of time.

In some aspects, the techniques described herein relate to a system, wherein the vulnerability is identified in multiple network devices or combinations of network devices by analyzing each SBOM to identify common software that is installed on the multiple network devices or the combinations of network devices.

In some aspects, the techniques described herein relate to one or more non-transitory computer readable storage media having program instructions embodied therewith, the program instructions executable by a computer to cause the computer to perform operations including: providing instructions to cause a plurality of network devices in a network to each generate a software bill of materials (SBOM), wherein each network device self-attests the SBOM that describes that network device; obtaining the SBOM from each of the plurality of network devices; analyzing each SBOM to identify a particular software configuration in the network; and identifying a vulnerability in the network based on the particular software configuration.

In some aspects, the techniques described herein relate to one or more non-transitory computer readable storage media, wherein the instructions to cause each network device to generate an SBOM are provided to an agent that is installed on each network device, and wherein the agent generates and self-attests the SBOM.

In some aspects, the techniques described herein relate to one or more non-transitory computer readable storage media, wherein the instructions to cause each network device to generate the SBOM are provided to a controller that manages one or more network devices of the plurality of network devices, and wherein the controller generates and self-attests the SBOM for each of the one or more network devices.

In some aspects, the techniques described herein relate to one or more non-transitory computer readable storage media, wherein the program instructions further cause the computer to: identify a subset of network devices that correspond to a particular network path through the network; and analyze the SBOM for each of the subset of network devices to identify a particular vulnerability that is present due to a combination of software installed on the subset of network devices.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
providing instructions to cause a plurality of network devices in a network to each generate a software bill of materials (SBOM), wherein each network device self-attests the SBOM that describes that network device;
obtaining the SBOM from each of the plurality of network devices;
analyzing each SBOM to identify a particular software configuration in the network; and
identifying a vulnerability in the network based on the particular software configuration.

2. The computer-implemented method of claim 1, wherein the instructions to cause each network device to generate an SBOM are provided to an agent that is installed on each network device, and wherein the agent generates and self-attests the SBOM.

3. The computer-implemented method of claim 1, wherein the instructions to cause each network device to generate the SBOM are provided to a controller that manages one or more network devices of the plurality of network devices, and wherein the controller generates and self-attests the SBOM for each of the one or more network devices.

4. The computer-implemented method of claim 1, further comprising:
identifying a subset of network devices that correspond to a particular network path through the network; and
analyzing the SBOM for each of the subset of network devices to identify a particular vulnerability that is present due to a combination of software installed on the subset of network devices.

5. The computer-implemented method of claim 1, wherein the vulnerability is identified based on the particular software configuration using a machine learning model.

6. The computer-implemented method of claim 1, further comprising:
analyzing each SBOM to identify a subset of the plurality of network devices that have received a software upgrade within a predetermined duration of time.

7. The computer-implemented method of claim 1, wherein the instructions to cause a plurality of network devices to each generate the SBOM are executed by each network device according to a predetermined schedule.

8. The computer-implemented method of claim 1, further comprising:
analyzing each SBOM to generate a trust score for the network.

9. The computer-implemented method of claim 1, wherein the vulnerability is identified in multiple network devices or combinations of network devices by analyzing each SBOM to identify common software that is installed on the multiple network devices or the combinations of network devices.

10. A system comprising:
one or more computer processors;
one or more computer readable storage media; and
program instructions stored on the one or more computer readable storage media for execution by at least one of the one or more computer processors, the program instructions comprising instructions to:
provide instructions to cause a plurality of network devices in a network to each generate a software bill of materials (SBOM), wherein each network device self-attests the SBOM that describes that network device;
obtain the SBOM from each of the plurality of network devices;
analyze each SBOM to identify a particular software configuration in the network; and
identify a vulnerability in the network based on the particular software configuration.

11. The system of claim 10, wherein the instructions to cause each network device to generate an SBOM are provided to an agent that is installed on each network device, and wherein the agent generates and self-attests the SBOM.

12. The system of claim 10, wherein the instructions to cause each network device to generate the SBOM are provided to a controller that manages one or more network devices of the plurality of network devices, and wherein the controller generates and self-attests the SBOM for each of the one or more network devices.

13. The system of claim 10, wherein the program instructions further comprise instructions to:
identify a subset of network devices that correspond to a particular network path through the network; and
analyze the SBOM for each of the subset of network devices to identify a particular vulnerability that is present due to a combination of software installed on the subset of network devices.

14. The system of claim 10, wherein the vulnerability is identified based on the particular software configuration using a machine learning model.

15. The system of claim 10, further comprising instructions to:
analyze each SBOM to identify a subset of the plurality of network devices that have received a software upgrade within a predetermined duration of time.

16. The system of claim 10, wherein the vulnerability is identified in multiple network devices or combinations of network devices by analyzing each SBOM to identify common software that is installed on the multiple network devices or the combinations of network devices.

17. One or more non-transitory computer readable storage media having program instructions embodied therewith, the program instructions executable by a computer to cause the computer to perform operations including:
providing instructions to cause a plurality of network devices in a network to each generate a software bill of materials (SBOM), wherein each network device self-attests the SBOM that describes that network device;
obtaining the SBOM from each of the plurality of network devices;
analyzing each SBOM to identify a particular software configuration in the network; and
identifying a vulnerability in the network based on the particular software configuration.

18. The one or more non-transitory computer readable storage media of claim 17, wherein the instructions to cause each network device to generate an SBOM are provided to an agent that is installed on each network device, and wherein the agent generates and self-attests the SBOM.

19. The one or more non-transitory computer readable storage media of claim 17, wherein the instructions to cause each network device to generate the SBOM are provided to a controller that manages one or more network devices of the plurality of network devices, and wherein the controller generates and self-attests the SBOM for each of the one or more network devices.

20. The one or more non-transitory computer readable storage media of claim 17, wherein the program instructions further cause the computer to:
identify a subset of network devices that correspond to a particular network path through the network; and
analyze the SBOM for each of the subset of network devices to identify a particular vulnerability that is present due to a combination of software installed on the subset of network devices.
